(19) United States
(12) Patent Application Publication
(10) Pub. No.: US 2005/0162750 A1
(43) Pub. Date: Jul. 28, 2005

(54) Fresnel lens spotlight

(75) Inventors: Rudiger Kittelmann, Einbeck (DE); Harry Wagener, Alfeld (DE)

Correspondence Address: Charles N. J. Ruggiero, Esq.;Ohlandt, Greeley, Ruggiero & Perle, L.L.P., 10th Floor, One Landmark Square, Stamford, CT, 06901-2682, US

(73) Assignee: Schott AG

(21) Appl. No.: 11/018,874

(22) Filed: Dec. 21, 2004

(30) Foreign Application Priority Data
Dec. 22, 2003 (DE) 103 61 118.5-54

(51) Int. Cl. F21V 1/00

(52) U.S. Cl. 359/636

(57) ABSTRACT

In order to produce a Fresnel lens spotlight whose emitted light beam has an adjustable aperture angle, having a preferably ellipsoid reflector, a lamp and at least one Fresnel lens, which has a more compact form and is thus not only more space-saving but is also lighter than the conventional Fresnel lens spotlight, a lens with a negative focal length and a virtual focal point is used as the Fresnel lens.

The invention relates to a Fresnel lens spotlight whose emitted light beam has an adjustable aperture angle, having a reflector, a lamp and at least one Fresnel lens.

Those parts of conventional Fresnel lens spotlights which are relevant for light purposes generally comprise a lamp, a Fresnel lens and a spherical auxiliary reflector. Conventionally, the lamp filament is located essentially in a fixed manner at the center point of the spherical reflector. In consequence, a portion of the light emitted from the lamp is reflected back into it, assisting the emission of light in the front hemisphere. This light which is directed forwards is focused by the Fresnel lens. The extent of light focusing is, however, dependent on the distance between the Fresnel lens and the lamp. If the lamp filament is located at the focal point of the Fresnel lens, then this results in the narrowest beam focusing. This results in a quasi-parallel beam path, also referred to as a spot. Shortening the distance between the Fresnel lens and the lamp results in the aperture angle of the emitted light beam being increased continuously. This results in a divergent beam path, which is also referred to as a flood.

Spotlights such as these have the disadvantage, however, of the poor light yield in particular when in their spot position, since only a relatively small spatial angle range of the lamp is covered by the Fresnel lens in this case. A further disadvantage is that a large proportion of the light which is reflected from the spherical reflector strikes the lamp filament itself again, while it is absorbed and additionally heats up the lamp filament.

DE 39 19 643 A1 discloses a spotlight having a reflector, having a diaphragm and having a Fresnel lens. The amount of light emitted from the spotlight is varied by adjusting the light source. This results in the brightness of the light being changed. The brightness is regulated by regulating the distance between the apex and the reflector and between the diaphragm.

DE 34 13 310 A1 discloses a spotlight with a lamp and a reflector or a lamp and a convergent lens. The spotlight also has a diffusing glass or a mirror, both of which are positioned at an angle of 45°. The mirror deflects the light, and the light is scattered by the diffusing glass. Different light beam emission angles are produced by moving the diffusing glass.

DE 101 13 385 C1 describes a Fresnel lens spotlight in which the Fresnel lens is a convergent lens whose focal point on the light source side is located at the spot position, approximately at the focal point of the ellipsoid reflector that is remote from the reflector. The distance between the focal points of the reflector, the focal length of the reflector and the focal length of the Fresnel lens are thus added to form the minimum length of a Fresnel lens spotlight such as this. Furthermore, both the distance ratio between the lamp and the reflector and the distance ratio between the reflector and the Fresnel lens are set as a function of one another by guidance with is appropriately complex to design. However, additional mechanical devices are required for this purpose.

The aim of the invention is, however, to provide a Fresnel lens spotlight which has a more compact form and, in consequence, is not only more space-saving but is also lighter than a conventional Fresnel lens spotlight. A further aim is to produce this Fresnel lens spotlight easily and at low cost, as well.

This object is achieved in a surprisingly simple manner by a Fresnel lens spotlight as claimed in claim 1, and by a lighting set as claimed in claim 17.

The use of a Fresnel lens with a negative focal length makes it possible to achieve an extremely compact form which, for example, in the spot position of the Fresnel lens spotlight, now corresponds essentially only to the length of the reflector together with the thickness of the respectively used Fresnel lens.

The Fresnel lens spotlight according to the invention results in considerably better light efficiency, particularly in the spot position, but also in the flood position.

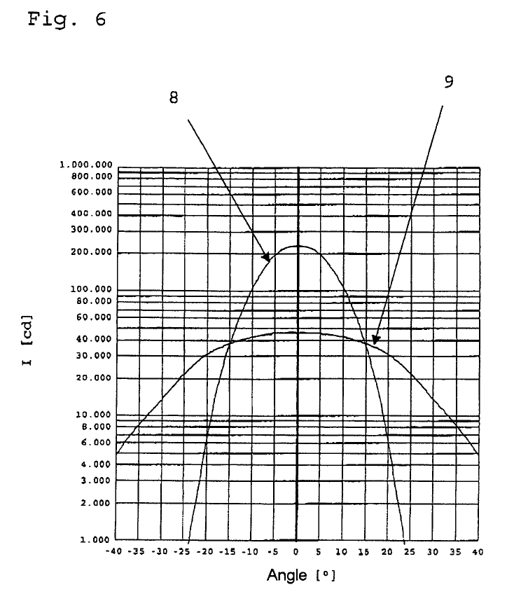

At the same time, the uniformity of the light intensity is maintained over the entire light field, as is illustrated by way of example in FIG. 6 both for the spot position and for the flood position.

According to the invention, an ellipsoid reflector with a large aperture is provided. The spot position is set by locating lamp filament of a black body emitter, in particular of a halogen lamp or the discharge arc of a discharge lamp, at the focal point of the ellipsoid on the reflector side, and by arranging the second focal point of the ellipsoid, which is remote from the reflector, approximately at the negative or virtual focal point of the Fresnel lens which is remote from the reflector.

The light which is reflected by the reflector is virtually completely focused on the focal point of the ellipsoid which is remote from the reflector, before it enters the negative lens. The lamp filament, which is located at the focal point on the reflector side, or the discharge arc is imaged at infinity after passing through the Fresnel lens, and its light is thus changed to a virtually parallel light beam.

The reflected light essentially no longer strikes the lamp filament or the discharge arc. The virtual negative focal point of the Fresnel lens coincides with the focal point of the reflector ellipsoid which is remote from the reflector, thus resulting in an extremely compact form.

If the aperture angle of the reflector and Fresnel lens is chosen expediently, the light which is reflected by the reflector is virtually all directed at the Fresnel lens, and is emitted forwards as a narrow spot light beam.

The light yield is thus considerably greater than in the case of conventional Fresnel lens spotlights.

One embodiment of the invention comprises the ellipsoid reflector being composed of a metallic or transparent material. Glass and polymer materials or plastics are preferably used, which can advantageously be coated with metal, for example aluminum.

Alternatively or in addition to the production of a reflective surface, one of the two or both surfaces of the reflector is or are provided with a system of optically thin layers. This advantageously results in visible radiation components being reflected, and in the invisible components, in particular thermal radiation components, being passed through.

A further preferred embodiment of the invention comprises a metallic coating on one or both main surfaces of the reflector.

In a further alternative refinement, the reflector may also be a metallic reflector, which may not only be uncoated but may also be dielectrically or metallically coated in order to produce the desired spectral and corrosion characteristics.

One preferred embodiment of the invention comprises a Fresnel lens spotlight in which the light-reflective surface of the reflector is structured to scatter light, and none, one or two surfaces of the Fresnel lens is or are structured to scatter light. This results in a fixed proportion of the superimposition of scattered light to geometrically/optically imaged light, which avoids imaging of the lamp in the light field. For this purpose, the reflector preferably has surface elements or facets which make it possible to calculate and to manufacture its light-scattering components in a defined manner.

With increasing miniaturization of the light source, for example in the important field of digital projection or for high-power discharge lamps, an evermore strongly pronounced central dark area may occur, however, which cannot be compensated for, or can be compensated for only with major light losses, by means of scattering devices within the reflector. Furthermore, the conventional scattering devices which are used to avoid imaging of the emission center of the light source overcome this only to a restricted extent, if at all, since in this case as well, at least the dark central aperture cone must be illuminated homogeneously in every position of the Fresnel lens spotlight. However, particularly in the spot position, this itself results in excessive light losses since only a dark area with a very small aperture angle is present here, but the full area of the Fresnel lens must nevertheless be used to scatter the light field in the case of conventional Fresnel lenses with scattering devices.

The inventors have found that these high light losses can be avoided in a surprisingly simple manner. In this case, it is particularly advantageous for the Fresnel lens to have a diffusing glass which, in a particularly preferred manner, is circular and is now arranged only at the center of the Fresnel lens.

In this embodiment, the dark areas in the center of the illuminating area can be very effectively avoided in every position of the Fresnel lens spotlight, without this resulting in excessively high light losses when the reflector is in the spot position.

Surprisingly, it has been found that the geometric/optical beam path of the light emerging from the reflector at the location of the Fresnel lens illuminates a smaller area precisely when the required proportion of scattered light is increased.

The inventors have made use of this effect in order by means of the invention to create an automatic or adaptive light mixing system which adds to the geometrically/optically imaged light, in synchronism with the movement of the Fresnel lens spotlight, only that scattered light component which is required for this position.

This light mixing ratio, which can be virtually optimally matched to the respectively required light distributions, will be referred to for short only as the mixing ratio in the following text.

This automatic light mixing system produces the correct mixing ratio essentially in every position of the reflector, thus always creating a highly homogeneously illuminated light field, without unnecessary scattering losses occurring in the process, however.

In this case, the mixing ratio of the Fresnel lens, whose entire area is illuminated, can be defined by the choice of the diameter of the integrated diffusing glass as a ratio to the remaining area of the Fresnel lens, and the aperture angle of the scattered light can be defined by the scattering characteristics of the negative lens.

Furthermore, the scattering effect of the integrated diffusing glass can itself be varied so that, for example, more strongly scattering areas are arranged at the center of the diffusing glass, and less strongly scattering areas are arranged at its edge. In consequence, a relatively strongly focused beam is additionally also widened, so that extremely wide illumination angles can then be achieved.

Alternatively, the edge of the diffusing glass can also be designed not only such that it ends abruptly, but can also be designed such that its scattering effect decreases continuously, still extending below or above the Fresnel lens. This allows further adaptations to the position-dependent mixing ratios.

Reference is made to the application, submitted on the same date, by the same applicant entitled “Optische Anordnung mit Stufenlinse” [Optical Arrangement with a Fresnel lens], whose disclosure content is also included completely, by reference, in the disclosure content of the present application.

According to the invention, the spotlight is intended to be used for architecture, medicine, film, stage, studio and photography as well as in a flashlight.

The diffusing glass in the preferred embodiments may be arranged either on the light inlet side or on the light outlet side. Furthermore, it is advantageously possible to arrange diffusing glasses at the light inlet or on the light outlet side. In this last-mentioned embodiment, it is also possible to use diffusing glasses with different scatter, for example diffusing glasses which scatter differently in different positions.

The invention will be described in more detail using preferred embodiments and with reference to the attached drawings, in which:

FIG. 1 shows an embodiment of the Fresnel lens spotlight in the spot position, with the focal point of the reflector which is remote from the reflector being approximately superimposed on the virtual focal point of the Fresnel lens on the right-hand side,

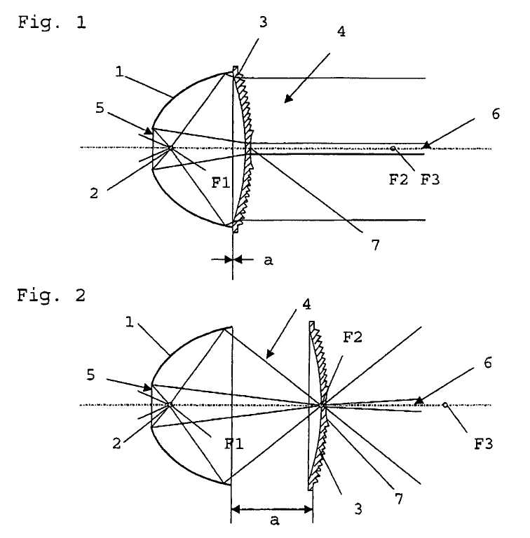

FIG. 2 shows the embodiment of the Fresnel lens spotlight as shown in FIG. 1 in a first flood position, with the focal point of the reflector which is remote from the reflector being arranged approximately on a surface of the Fresnel lens which is close to the reflector,

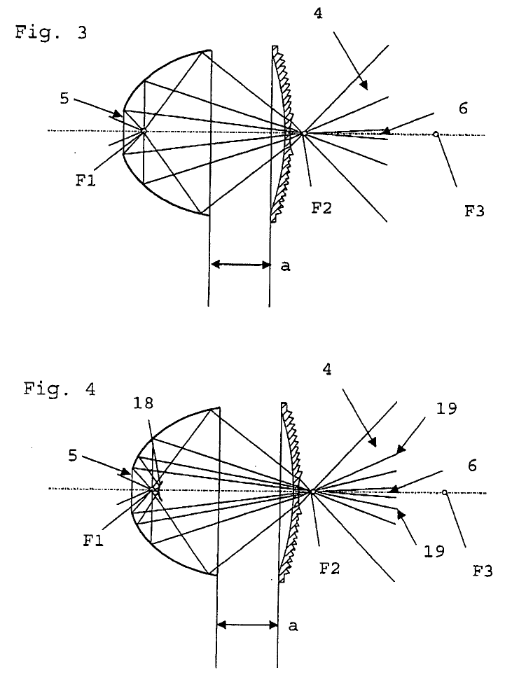

FIG. 3 shows the embodiment of the Fresnel lens spotlight as shown in FIG. 1 in a second flood position with a larger aperture angle, with the focal point of the reflector which is remote from the reflector being imaged by the Fresnel lens in front of that surface of the Fresnel lens which is remote from the reflector,

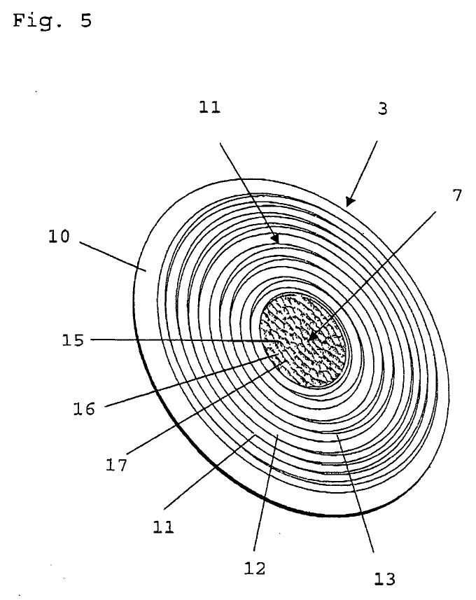

FIG. 4 shows the embodiment of the Fresnel lens spotlight as shown in FIG. 1 in its second flood position with a larger aperture angle, with a further portion of the light initially being passed by means of an auxiliary reflector into the reflector and from there into the Fresnel lens,

FIG. 5 shows a negative Fresnel lens with a centrally arranged diffusing glass and,

FIG. 6 shows a logarithmic representation (which is dependent on the aperture angle) of the light intensity of the Fresnel lens spotlight in its spot position and in one of its flood positions.

### DETAILED DESCRIPTION OF PREFERRED EMBODIMENTS

In the following detailed description, the same reference symbols are used to denote the same elements or elements having the same effect in each of the various embodiments.

The following text refers to FIG. 1, which shows one embodiment of the Fresnel lens spotlight in the spot position. The Fresnel lens spotlight essentially contains an ellipsoid reflector 1, a lamp 2 which may be a halogen lamp or else a discharge lamp, and a Fresnel lens 3, which is a lens with negative refractive power, preferably a biconcave Fresnel lens.

In FIG. 1, the focal point F2 of the ellipsoid reflector 1 which is remote from the reflector is approximately superimposed on the virtual or negative focal point F3 of the Fresnel lens 3 on the right-hand side.

The light beam 4 which is emitted from the spotlight is indicated only schematically in the figures, by its outer edge beams.

The spot position is set by arranging the lamp filament or the discharge arc of the lamp 2 essentially at the focal point F1 of the reflector ellipsoid 1 on the reflector side.

The light which is reflected by the reflector 1 is, in this position, directed virtually completely at the focal point F2 of the ellipsoid 1 which is remote from the reflector. The right-hand side negative or virtual focal point F3 of the Fresnel lens 3 then coincides approximately with the focal point F2 of the reflector ellipsoid.

The near field in FIG. 1 also shows how the opening 5 within the reflector 1 acts as a dark area 6 in the parallel beam path of the light field 4.

A circular, centrally arranged diffusing glass 7 is provided within the Fresnel lens 3, and produces a defined scattered light ratio and a defined aperture angle of the scattered light. This results in a defined mixing ratio of the scattered light relative to the light which is geometrically-optically imaged by the Fresnel lens 3.

As an alternative to this embodiment of the diffusing glass 7, the scattering effect in a further embodiment changes along the radius of the diffusing glass 7 continuously, such that more strongly scattering areas are arranged at the center of the diffusing glass 7, and less strongly scattering areas are arranged at its edge, which ends abruptly.

In yet another alternative refinement, the edge of the diffusing glass 7 is not only designed such that it ends abruptly, but is also designed such that its scattering effect decreases continuously, and this may also extend under or above the Fresnel lens.

In consequence, further adaptations to the position-dependent mixing ratios are carried out as a function of the system, so that a person skilled in the art can always provide an optimum mixing ratio for a homogeneously illuminated light field or else for light fields with locally higher intensities which are produced in a defined manner.

FIG. 1 also shows that only a small proportion of the total light passes through the diffusing glass 7 in the spot position.

The diffusing glass 7 results in very homogeneous illumination, as is shown by the line 8 for the spot position in FIG. 6, which shows a logarithmic representation (which is dependent on the aperture angle) of the light intensity of the Fresnel lens spotlight.

FIG. 2 shows the embodiment of the Fresnel lens spotlight as illustrated in FIG. 1 in a first flood position, in which the focal point F2 of the reflector 1 which is remote from the reflector is arranged approximately on a surface of the Fresnel lens 3 which is close to the reflector.

In this case, the value of the shift a with respect to the spot position is changed in a defined manner by means of a mechanical guide.

Fundamentally, the design corresponds to the design of the Fresnel lens spotlight explained in FIG. 1.

However, as can clearly be seen from FIG. 2, both the aperture angle of the emitted light beam 4 and that of the dark area 6 have increased.

However, since a very large proportion of the light in this position strikes only a very small area in the center of the diffusing glass 7, this area can in fact be designed such that its forward scattering lobe compensates approximately for the dark area 6 in the far field or far area in a desired manner. Reference should also be made to FIG. 6, which shows the light conditions with the line 9, for example for a flood position.

The following text refers to FIG. 3, which shows the embodiment illustrated in FIG. 1 of the Fresnel lens spotlight in a second flood position with an even larger aperture angle than in FIG. 2, with the focal point F2 of the reflector 1 which is remote from the reflector being imaged by the Fresnel lens 7 in front of that surface of the Fresnel lens 7 which is remote from the reflector.

In this case, a larger area of the diffusing glass 7 has light passing through it than shown in FIG. 2, and its overall scattering behavior can be matched to the relationships of this flood position.

FIG. 4 shows a further preferred embodiment. In this embodiment, which corresponds essentially to the embodiments described above except for having an additional auxiliary reflector 18, the auxiliary reflector 18 deflects the light from the lamp 2 (which would propagate to the right in FIG. 4 and would no longer reach the reflector 1) into the reflector 1 by reflection. In consequence, not only can the light which is represented merely by way of example by the beam path 19 and which would not contribute to the illumination without the auxiliary reflector be used, but it is also possible to use that portion of the light which otherwise enters the Fresnel lens 3 directly better for the desired light distribution.

The shape of the auxiliary reflector 18 is advantageously chosen such that light which is reflected on it does not enter the means of producing light in the lamp 2 again, for example a filament or a discharge zone, and does not unnecessarily heat it as well.

Alternatively, the auxiliary reflector 18 may be fitted to the inner face or outer face of the glass body of the lamp 2. The glass of the lamp body may be appropriately shaped for this purpose, in order to achieve the desired directional effect for the reflected light.

By way of example, FIG. 5 shows a Fresnel lens 3 with a diffusing glass 7, as is used by the invention. The Fresnel lens 3 has a transparent base body 10 as well as a Fresnel lens ring system 11 with annular lens sections 11, 12, 13, between which the circular diffusing glass 7 is arranged.

The diffusing glass 7 is structured in a defined manner or has facets 15, 16, 17 with a scattering behavior which can be defined exactly within wide limits, which facets 15, 16, 17 are described in German Patent Application DE 103 43 630.8 from the same applicant entitled “Streuscheibe” [Diffusing glass], which was submitted to the German Patent and Trademark Office on September 19. The disclosure content of this application is also in its entirety included by reference in the disclosure content of this application.

However, the invention is not restricted to this already described embodiment of diffusing glasses.

The Fresnel lens spotlight described above is particularly advantageously used in a lighting set together with an electrical power supply unit or ballast, which is considerably smaller than in the case of the prior art. This power supply unit can be designed both electrically and mechanically to be smaller for the same usable light power than in the case of the prior art, since the Fresnel lens spotlight according to the invention has a considerably higher light yield. Less weight is therefore required, and a smaller storage space is occupied for transportation and storage.

However, particularly when using cold light reflectors, this also reduces the total thermal load on illuminated people and objects.

Furthermore, the Fresnel lens spotlight according to the invention can advantageously also be used to increase the light yield from flashlights in which, in principle, the available electrical energy is more severely limited.

List of Reference Symbols

1 Reflector
2 Lamp
3 Fresnel lens
4 Emitted light beam
5 Opening in the reflector 1
6 Dark area
7 Diffusing glass
8 Intensity distribution in the spot position
9 Intensity distribution in the flood position
10 Base body
11 Fresnel lens ring system
12 Annular lens sections
13 Ditto
14 Ditto
15 Facet
16 Ditto
17 Ditto
18 Auxiliary reflector
19 Beam path reflected by the auxiliary reflector

1. A Fresnel lens spotlight having an emitted light beam with an adjustable aperture angle, comprising:
an ellipsoid reflector;
a lamp; and
at least one Fresnel lens, having a negative focal length that defines a virtual focal point.

2. The Fresnel lens spotlight as claimed in claim 1, wherein the ellipsoid reflector has a reflector focal point that is remote from the ellipsoid reflector, so that the reflector focal point can be superimposed on the virtual focal point in the spot position of the Fresnel lens spotlight.

3. The Fresnel lens spotlight as claimed in claim 1, wherein the at least one Fresnel lens is a biconcave negative lens.

4. The Fresnel lens spotlight as claimed in claim 1, wherein the at least one Fresnel lens comprises a double lens with chromatically corrected imaging characteristics.

5. The Fresnel lens spotlight as claimed in claim 1, wherein the at least one Fresnel lens comprises an integrated diffusing glass.

6. The Fresnel lens spotlight as claimed in claim 5, wherein the integrated diffusing glass is circular and is arranged at the center of the at least one Fresnel lens.

7. The Fresnel lens spotlight as claimed in claim 1, wherein the ellipsoid reflector comprises a metallic or transparent dielectric glass and/or plastic.

8. The Fresnel lens spotlight as claimed in claim 1, wherein the ellipsoid reflector comprises at least one surface having a system of optically thin layers.

9. The Fresnel lens spotlight as claimed in claim 5, wherein the ellipsoid reflector is structured to scatter light, and/or the at least one Fresnel lens is structured to scatter light.

10. (Cancelled)

11. The Fresnel lens spotlight as claimed in claim 5, wherein the ellipsoid reflector, the at least one Fresnel lens and/or the integrated diffusing glass are/is coated on at least one side.

12. The Fresnel lens spotlight as claimed in claim 11, wherein the coating on the at least one Fresnel lens is a dielectric interference layer system that changes the spectrum of the light passing through it.

13. The Fresnel lens spotlight as claimed claim 1, wherein the ellipsoid reflector comprises a surface coated with aluminum.

14. The Fresnel lens spotlight as claimed in claim 1, wherein the lamp is selected from the group consisting of a halogen lamp, a light-emitting diode, a light-emitting diode array, and a gas discharge lamp.

15. The Fresnel lens spotlight as claimed in claim 1, further comprising an auxiliary reflector arranged between the at least one Fresnel lens and the ellipsoid reflector.

16. The Fresnel lens spotlight as claimed in claim 1, wherein the at least one Fresnel lens is thermally prestressed, on its surface.

17. A lighting set comprising:
an ellipsoid reflector;
a lamp;
a Fresnel lens having a negative focal length that defines a virtual focal point; and
an associated electrical power supply unit or ballast.

18. (Cancelled).

19. A flashlight comprising:
an ellipsoid reflector;
a lamp;
a Fresnel lens having a negative focal length that defines a virtual focal point; and
an electrical energy source.

20. The Fresnel lens spotlight as claimed in claim 6, wherein the integrated diffusing glass defines a light mixing system that changes a proportion of scattered light relative to a proportion of optically imaged light as a function of the position of the Fresnel lens spotlight.

21. The lighting set as claimed in claim 17, wherein the ellipsoid reflector has a reflector focal point that is remote from the ellipsoid reflector so that the reflector focal point can be superimposed on the virtual focal point in the spot position of the lighting set.

22. The flashlight as claimed in claim 19, wherein the ellipsoid reflector has a reflector focal point that is remote from the ellipsoid reflector so that the reflector focal point can be superimposed on the virtual focal point in the spot position of the flashlight.
